(19) United States
(12) Patent Application Publication
(10) Pub. No.: US 2022/0194685 A1
(43) Pub. Date: Jun. 23, 2022

(54) AEROSOL CONTAINER, ACTUATOR AND PROTECTIVE MEMBER FOR AEROSOL CONTAINER

(71) Applicant: TOYO SEIKAN CO., LTD., Tokyo (JP)

(72) Inventors: Atsushi Kominami, Yokohama-shi, Kanagawa (JP); Soji Araki, Yokohama-shi, Kanagawa (JP)

(21) Appl. No.: 17/603,179

(22) PCT Filed: Apr. 10, 2020
(86) PCT No.: PCT/JP2020/016097

§ 371 Date: Oct. 12, 2021

(30) Foreign Application Priority Data
Apr. 12, 2019 (JP) 2019-076620

(51) Int. Cl. B65D 83/20; B65D 83/48

(52) U.S. Cl. CPC B65D 83/20; B65D 83/48

(57) ABSTRACT

Provided are an aerosol container, an actuator and a protective member for the aerosol container, with high safety capable of preventing breakage of a valve mechanism when an excessive impact acts on a stem in an axial direction. The present invention provides an aerosol container in which an actuator is attached to a stem, characterized in that a safety mechanism part is provided in a part of a path through which an external force is transmitted to the stem, the safety mechanism part being configured to prevent breakage a valve mechanism of the aerosol container against an excessive external force which exceeds a force required for discharge operation of contents and which may damage the valve mechanism.

### TECHNICAL FIELD

The invention relates to an aerosol container that ejects its contents by gas pressure, and more particularly, to an aerosol container equipped with a safety mechanism to prevent damage to a valve mechanism from the impact of a fall from a high place such as a construction site or an unmanned aerial vehicle. The invention also relates to an actuator and a protective member for an aerosol container.

### BACKGROUND ART

As a conventional safety mechanism for this type of aerosol container, there is for example known a safety mechanism described in Patent Literature 1.

In this Patent Literature 1, there is disclosed a spray nozzle protector that is attached to a mounting cup of a spray can (aerosol container). The protector has two hollow cylinders with different diameters, and is configured such that a large diameter portion is inserted so as to cover the mounting cup of the spray can, and a small diameter portion surrounds a nozzle stem that serves to introduce contents from the spray can to a spray nozzle.

When an impact is applied to the spray nozzle from a lateral direction, the small diameter portion of the protector absorbs an external force applied to the nozzle stem to mitigate the impact, thereby preventing the nozzle stem from being deformed to an extent that the nozzle stem cannot be reused.

### CITATION LIST

### Patent Literature

Patent Literature 1: Japanese Patent Application Laid-Open Publication No. H10-258884

### SUMMARY OF INVENTION

### Technical Problem

However, the protector described in Patent Literature 1 prevents bending deformation of the stem against an impact load in the lateral direction, but there is no description about breakage of the valve mechanism when an impactive load acts on the stem in the axial direction.

The valve mechanism is provided in a housing attached to the inner side of the can of the mounting cup, and an end portion of the stem inserted into the housing is urged by a spring in a direction to protrude to the outer side of the can, whereby the valve mechanism is held in a normally closed state. When an impact is applied in a direction to push the stem inward into the can, the end portion of the stem will bite into the housing of the valve mechanism, or the spring will be damaged, and will not be able to return to a valve closing direction, so that the contents may spurt out and contaminate the surroundings.

The present invention has been made to solve the above-described problems of the prior art, and an object thereof is to provide an aerosol container, an actuator and a protective member for the aerosol container, with high safety capable of preventing breakage of a valve mechanism when an excessive impact acts on a stem in an axial direction.

### Solution to Problem

In order to achieve the above object, the present invention provides an aerosol container in which an actuator is attached to a stem, characterized in that a safety mechanism part is provided in a part of a path through which an external force is transmitted to the stem, the safety mechanism part being configured to prevent breakage a valve mechanism of the aerosol container against an excessive external force which exceeds a force required for discharge operation of contents and which may damage the valve mechanism.

According to the present invention, by providing the safety mechanism part, it is possible to mitigate an impact acting on the inside valve mechanism via the stem at the time of falling from a high place or the like, thereby making it possible to prevent breakage of the valve mechanism.

The present invention can also be configured as follows.

1. The safety mechanism part comprises a fragile part that can be destroyed by the excessive external force.

The fragile part may be merely formed of a portion that is fragile, and can be manufactured at low cost, and can reliably mitigate the impact on the valve mechanism.

2. The safety mechanism part comprises a frictional contact part where a contact surface slips due to the excessive external force to mitigate the transmission of force.

The frictional contact part can be manufactured at low cost by adjusting the friction force according to its property such as a contact surface pressure, a friction coefficient of the contact surface, or the like and can reliably mitigate the impact on the valve mechanism.

3. The safety mechanism part comprises a deformable part where the transmission of force is mitigated by deformation thereof due to the excessive external force.

For the deformable part, the rigidity thereof can be changed by the thickness of a structural part, etc., and hence the structure of the actuator remains unchanged, is easy to manufacture, and reliably mitigates the impact on the valve mechanism.

4. The safety mechanism part comprises connecting parts that are fitted or engaged with each other, and is configured to be released or disengaged by the excessive external force.

It is only necessary to provide joints between structural parts and connect them, and hence production thereof is easy. In addition, since the connecting parts are only separated from each other, they can be repeatedly used if connected. Moreover, no special material is required, and the impact on the valve mechanism can be avoided with an inexpensive and simple configuration.

5. The safety mechanism part is configured to block the transmission of force by means of a stopper that regulates the stroke of the stem.

Since a stopper mechanism only regulates the stroke of the stem, a special structure is not required, and reliability is high.

6. Provision is made for a protective member covering a clinch portion that serves to fix a container body portion and a lid body.

With the provision of the protective member, it is also possible to prevent leakage of contents due to damage to the clinch portion caused by the impact.

In addition, of the present invention

7. The actuator has a fitting portion to be fitted to the stem, and the safety mechanism part is provided in the fitting portion.

By providing it in the fitting portion, it can be manufactured at low cost, and can reliably mitigate the impact on the valve mechanism.

8. The actuator has a flange portion protruding from the fitting portion to be fitted to the stem, and the safety mechanism part is provided in the flange portion.

By providing it in the flange portion, it can be manufactured at low cost, and can reliably mitigate the impact on the valve mechanism.

In addition, an actuator for an aerosol container of the present invention, in which the actuator is adapted to be attached to a stem of the aerosol container, is characterized in that a safety mechanism part is provided in a part of a path through which an external force is transmitted from the actuator to the stem, the safety mechanism part being configured to prevent breakage of a valve mechanism of the aerosol container against an excessive external force which exceeds a force required for discharge operation of contents and which may damage the valve mechanism.

Moreover, a protective member for an aerosol container of the present invention is characterized by comprising: an engagement portion adapted to engage with a clinch portion that fixes a body portion and a lid body of the aerosol container; and a protective member main body that covers the clinch portion.

### Advantageous Effects of Invention

As described above, according to the present invention, by providing the safety mechanism part, it is possible to mitigate an impact acting on the stem at the time of falling from a high place or the like, thus making it possible to prevent breakage of the valve mechanism portion.

### BRIEF DESCRIPTION OF THE DRAWINGS

FIG. 1(A) is a schematic cross-sectional view of an aerosol container in a valve closed state according to a first embodiment of the present invention; FIG. 1(B) is a cross-sectional view of a main part in a valve opened state; and FIG. 1(C) is a plan view of a fragile part of FIG. 1(A).

FIG. 2 schematically illustrates a state in which an aerosol container has fallen to the ground, wherein FIG. 2(A) illustrates a state before the fragile part is destroyed; FIG. 2(B) illustrates a state after the fragile part is destroyed; and FIG. 2(C) illustrates a broken state of a valve mechanism in the case where there is no fragile part.

FIG. 3(A) is a schematic cross-sectional view illustrating a configuration of a main part of an aerosol container according to a second embodiment; FIG. 3(B) is a plan view of a small diameter portion; FIG. 3(C) is a schematic cross-sectional view illustrating a state before the diameter of the small diameter portion is expanded at the time of falling; and FIG. 3(D) is a schematic cross-sectional view illustrating a state after the diameter of the small diameter portion is expanded.

FIG. 4(A) is a schematic cross-sectional view illustrating a configuration of a main part of an aerosol container according to a third embodiment; FIG. 4(B) is a plan view of a flange fragile part; FIG. 4(C) is a schematic cross-sectional view illustrating a state before the flange fragile part is destroyed at the time of falling; and FIG. 4(D) is a schematic cross-sectional view illustrating a state after the flange fragile part is destroyed.

FIG. 5(A) is a schematic cross-sectional view illustrating a configuration of a main part of an aerosol container according to a fourth embodiment; FIG. 5(B) is a plan view of a flange deformable part; FIG. 5(C) is a schematic cross-sectional view illustrating a state before deformation of the flange deformable part at the time of falling; and FIG. 3(D) is a schematic cross-sectional view illustrating a state after deformation of the flange deformable part.

FIG. 6(A) is a schematic cross-sectional view illustrating a configuration of a main part of an aerosol container according to a fifth embodiment; FIG. 6(B) is a plan view of flange connecting parts; FIG. 6(C) is a schematic cross-sectional view illustrating a state before separation of the flange connecting parts at the time of falling; and FIG. 3(D) is a schematic cross-sectional view illustrating a state after separation of the flange connecting parts.

FIG. 7(A) is a schematic cross-sectional view illustrating a configuration of a main part of an aerosol container according to a sixth embodiment; FIG. 7(B) is a schematic cross-sectional view illustrating a state before the stroke of a stem is regulated at the time of falling; and FIG. 7(C) is a schematic cross-sectional view illustrating a state in which the stroke of the stem is regulated.

FIG. 8(A) is a schematic cross-sectional view illustrating a configuration of a main part of an aerosol container according to a seventh embodiment; FIG. 8(B) is a schematic cross-sectional view illustrating a state before the stroke of a stem is regulated at the time of falling; and FIG. 8(C) is a schematic cross-sectional view illustrating a state in which the stroke of the stem is regulated.

FIG. 9(A) is a schematic cross-sectional view illustrating a configuration of a main part of an aerosol container according to an eight embodiment; and FIG. 9(B) is a schematic cross-sectional view after a fragile part is destroyed.

### EMBODIMENTS FOR CARRYING OUT THE INVENTION

Hereinafter, the present invention will be described in detail on the basis of embodiments illustrated in the drawings.

The dimensions, materials, shapes, relative arrangements, etc., of the components described in the following embodiments should be changed as appropriate depending on the configuration and various conditions of an apparatus to which the invention is applied, and are not intended to limit the scope of the invention to the following embodiments.

### First Embodiment

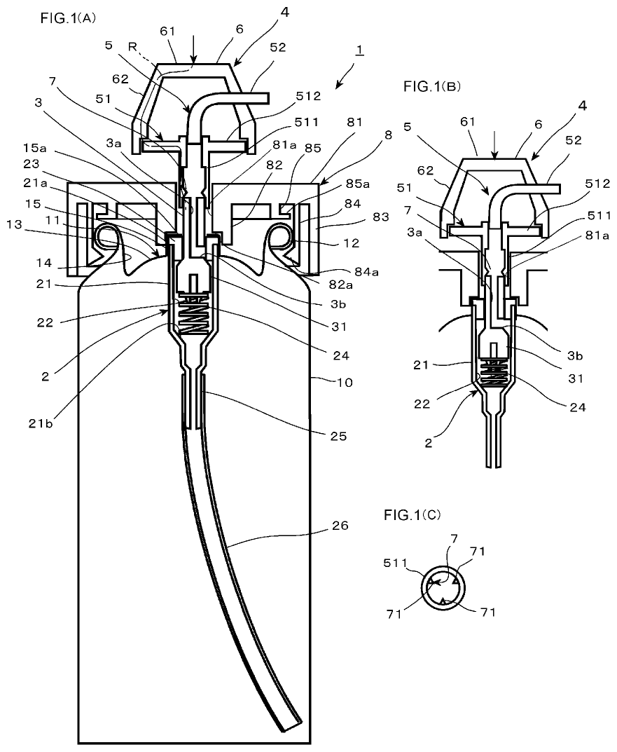

FIG. 1 conceptually illustrates an aerosol container according to a first embodiment of the present invention, wherein FIG. 1(A) illustrates a valve closed state and FIG. 1(B) illustrates a valve opened state.

The overall configuration of the aerosol container 1 includes a container body 10 for containing contents, a mounting cup 11, a valve mechanism 2 attached to the mounting cup 11, a stem 3 that protrudes from the mounting cup 11 for operating the valve mechanism 2 to open its valve and has a flow path, an actuator 4 attached to the stem 3, and a protective member 8 for covering a clinch portion 12 that fixes the container body 10 and the mounting cup 11. In the first embodiment, a fragile part 7 is provided in a part of a path R through which an external force from the actuator 4 to the stem is transmitted, wherein the fragile part 7 acts as a safety mechanism part that mitigates the transmission of force in a direction to prevent breakage of the valve mechanism against an excessive external force which exceeds a force required for the discharge operation of contents and which may break the valve mechanism 2.

The aerosol container 1 is a container whose contents are ejected by the gas pressure of a propellant such as liquefied gas or compressed gas filled inside, and the form of the propellant and the contents sealed in the aerosol container 1 may be an isolated type in which a base or stock solution is contained in an inner bag and the propellant is contained between the outer periphery of the inner bag and the inner periphery of the container body, or it may be a two phase or three phase container, or in cases where the stem is used downward, a two phase or three phase container having no dip tube can be applied. In the present embodiment, a form having a dip tube 26 is illustrated as an example.

### [Container Body and Mounting Cup]

The container body 10 has a bottomed cylindrical shape, and a mounting cup 11 is fixed to a diameter-reduced opening end portion of the container body 10 by a clinch portion 12. The bottom portion of the container body 10 may be formed by seaming and fixing a bottom lid to the body portion, or may be integrally formed.

The mounting cup 11 includes a dome-shaped lid portion 13 that covers an opening portion of the container body 10, a fixed tube (or cylinder) portion 14 that rises from an outer peripheral edge of the lid portion 13, and a central protruding portion 15 that protrudes to a central portion of the lid portion 13, wherein an end portion of the fixed tube portion 14 is fixed to an opening end portion of the container body 10 in a sealed state by means of the clinch portion 12. The clinch portion 12 is a portion that is sealed by overlapping a reduced-diameter opening end portion of the container body 10 and an opening end portion of the fixed tube portion 14 via a gasket (not shown) and folding back the overlapped portions from the inside to the outside into a circular cross-sectional shape.

### [Valve Mechanism]

The valve mechanism 2 is assembled to the mounting cup 11, and a valve chamber 22 is formed by a housing 21 whose one end is fitted and fixed to the inner periphery of the central protruding portion 15 of the mounting cup 11. The stem 3 is inserted into an insertion hole formed in a central end wall 15a of the central protruding portion 15, and a valve body portion 31 that bulges to a large diameter is provided at an end portion of the stem on the valve chamber 22 side. A space between the central end wall 15a of the mounting cup 11 and a distal end surface 21a of the housing 21 is sealed by a washer-like gasket 23, and the inner periphery of the gasket 23 is in slidable sealing contact with the outer periphery of the stem 3.

The valve body portion 31 in the valve chamber 22 is configured to come into contact with and separate from the gasket 23 in the axial direction as the stem 3 moves, and a valve body contact portion of the gasket 23 functions as a valve seat. A spring 24 as an urging means for urging the valve body 31 toward the gasket 23 (in a valve closing direction) is mounted between the valve body 31 of the stem 3 and the bottom wall portion 21b of the housing 21 in the valve chamber 22, and the valve body portion 31 is pressed against the inner peripheral edge portion of the gasket 23 by the urging force of the spring 24 and the pressure of the contents flowing into the valve chamber due to the gas pressure, so that the valve body portion 31 is held in a valve closed state.

In addition, the stem 3 is provided with a discharge flow path 3a extending by a predetermined dimension in the axial direction from its distal end side opening portion side exposed to the outside to a position in front of the valve body portion 31, and a stem hole 3a communicating with the discharge flow path 3b at a position before the valve body portion 31 on the side surface of the stem 3. This stem hole 3b is closed by the gasket 23 in the valve closed state, and when the stem 3 is pushed into the valve chamber side and the valve body portion 31 is separated from the gasket 23, the stem hole 3a is opened to the valve chamber 22 side, so that the contents are discharged through the discharge flow path SL. Here, note that a nipple portion 25 protrudes from the bottom wall portion 21b of the housing 21, one end of the dip tube 26 is connected to the nipple portion 25, and the contents are filled into the valve chamber 22 through the dip tube 26 under the action of gas pressure.

The valve configuration of the illustrated example is merely shown exemplarily, and various configurations in which a valve is opened and closed by operating the stem 3 can be applied as a valve configuration.

This valve mechanism 2 is not limited to the above-described configuration, but various configurations in which the valve is opened by pushing in the stem 3 can be applied.

### [Actuator]

The actuator 4 is an operating portion for discharging the contents, and includes a button for spraying the contents in the form of a mist or jet, and a spout for spraying in the form of a bubble or foam. The actuator 4 of the present embodiment includes an actuator body 5 and a push member 6 attached to the actuator body 5.

The actuator body 5 includes a joint member 51 fixed to the stem 3 and a nozzle portion 52 connected to the stem 3 through the joint member 51.

The joint member 51 includes a fixed tube portion 511 having one end fixed to the stem 3 and a flange portion 512 provided at the other end of the fixed tube portion 511, wherein one end of the nozzle portion 52 is connected to the other end of the fixed tube portion 511.

The push member 6 includes a push plate portion 61 and a skirt portion 62 extending from the peripheral edge of the push plate portion 61 toward the container body 10 so as to surround the nozzle portion 52, wherein an end portion of the skirt portion 62 is fixed to an outer diameter end portion of the flange portion 512 of the joint member 51.

In addition, the nozzle portion 52 is bent in an L-shape, and a discharge end thereof is exposed to the outside from the skirt portion 62 of the push member 6, so that the contents are discharged from the side of the push member 6 with respect to the axial direction of the stem 3.

In the illustrated example, the nozzle portion 52 is bent in the L-shape, but the nozzle portion 52 may be configured to extend in the axial direction of the stem 3. The nozzle portion 52 may be provided with an orifice, and various forms can be selected depending on whether the contents are discharged in a mist form or in a linear jet flow, or depending on the discharge form and discharge direction of the contents.

Here, note that in the present embodiment, the actuator 4 is illustrated by way of example as configured such that the push member 6 for manual operation is formed integral with the actuator body 5, but it is not limited to such an integrated configuration, and the push member 6 may be a separate configuration. For example, in the case of automatic ejection as in the case of the actuator being mounted on an unmanned aerial vehicle, the stem 3 is pushed in via the actuator 4 by a drive device, and hence in this case, the push member 6 is configured to be separate from the actuator body.

### [Fragile Part 7 (Safety Mechanism Part)]

The fragile part is provided in a part of a path through which an external force is transmitted to the stem 3.

The path through which the external force is transmitted is a path through a structural part of the actuator 4 which extends from an external force acting portion of the actuator 4 to the stem 3, and varies depending on the position of the external force acting portion and the configuration of the actuator. The external force is assumed to be a force with an axial load component acting on the stem 3, and in the case of the actuator 4 of this embodiment, when an external force acts on the push plate portion 61 of the push member 6, a transmission path R of the external force is a path leading from the push plate portion 61 of the push member 6 to the stem 3 through the skirt portion 62, the flange portion 512 and the fixed tube portion 511 of the joint member 51.

In the first embodiment, the fragile part 7 is provided at a fitting or engaging portion between the fixed tube portion 511 of the joint member 51 and the stem 3.

The fragile part 7 is formed by engagement claws 71 that protrude inward from the inner periphery of the fixed tube portion 511. The engagement claws 71 are partially formed at intervals in the circumferential direction, and normally engage with the distal end surface of the fixed tube portion 511 to transmit a pushing force from the push member 6 to the stem 3. When an excessive external force is applied which exceeds the force required for the discharge operation of the contents and may damage the valve mechanism 2, the engagement claws are configured to be destroyed to mitigate the transmission of the force in a direction to prevent breakage of the valve mechanism 2, thereby protecting the valve mechanism 2.

### [Protective Member]

The protective member 8 includes: a washer-shaped top plate portion 81 that has a hole 81a through which the stem 3 and the fixed tube portion 511 pass, and covers the mounting cup 11, the clinch portion 12 and a shoulder portion of the container body 10; a cylindrical inner tube portion 82 that extends from a radially inner end of the top plate portion 81 toward the mounting cup; and an outer tube portion 83 that extends from a radially outer end of the top plate portion 81 toward the shoulder portion of the container body 10 to cover the clinch portion 12 from its side. The inner tube portion 82 is provided at its end portion on the mounting cup 11 side with an engagement step portion 82a that engages with an outer peripheral corner portion of the central end wall 15a of the central protruding portion 15 of the mounting cup 11.

On the other hand, the top plate portion 81 is provided at its opposite surface facing the clinch portion 12 with a cylindrical engagement tube portion 84 that elastically engages with an outer peripheral side of the clinch portion 12 and an abutment tube portion 85 that abuts against a top portion of the clinch portion 12. The abutment tube portion 85 is provided at its distal end with an overhang piece 85a that overhangs or protrudes outward in the radial direction by a predetermined amount, and the overhang piece 85a abuts against the top portion of the clinch portion 12. The engagement tube portion 84 is provided at its lower end with an engagement protrusion 84a protruding radially inward and engaging with a lower edge of the clinch portion 12, wherein the engagement protrusion 84a engages with the lower edge of the clinch portion 12 in a state where the overhang piece 85a at the distal end of the abutment tube portion 85 abuts against the top portion of the clinch portion 12, whereby the protective member 8 is fixed to the container without play or looseness in the radial direction and in the axial direction.

The top plate portion 81 and the inner tube portion 82 of the protective member 8 are configured to be thick so as to withstand the impact of a fall or the like, so that the impact is dispersed and transmitted to the clinch portion 12. On the other hand, the abutment tube portion 85 and the overhang piece 85a that abut against the clinch portion 12 are set to be thin so as to mitigate the load that is dispersed and transmitted by the top plate portion 81.

In addition, the outer tube portion 83 has a function of protecting the pieces of the engagement tube portion 84 and the outer peripheral side of the clinch portion 12, and also has a function of further increasing the rigidity of the top plate portion 81. A predetermined gap is formed between the outer tube portion 83 and the engagement tube portion 84, so that even if the outer tube portion is subjected to an impact and is deformed, it will not interfere with the engagement tube portion 84.

The mounting of the protective member 8 is performed before the actuator 4 is mounted. The mounting operation is performed by bringing the engagement projection 84a of the engagement tube portion 84 into contact with the top portion of the clinch portion 12, and pushing the engagement tube portion 84 into the clinch portion 12. By being pushed in, the engagement tube portion 84 is elastically deformed to expand the inner diameter of the engagement projection 84a, so that the engagement projection 85a rides over the clinch portion 12 to engage with the lower edge of the clinch portion 12, and the projection piece 85a of the abutment tube portion 85 abuts with the top portion of the clinch portion 12 to pinch the clinch portion 12 in the axial direction to fix it. In this state, the engagement step portion 82a of the inner tube portion 82 is also engaged with the corner portion of the central end wall 15a of the central protruding portion 15 of the mounting cup 11.

Next, the operation of the fragile part 7 of the aerosol container according to the first embodiment will be described.

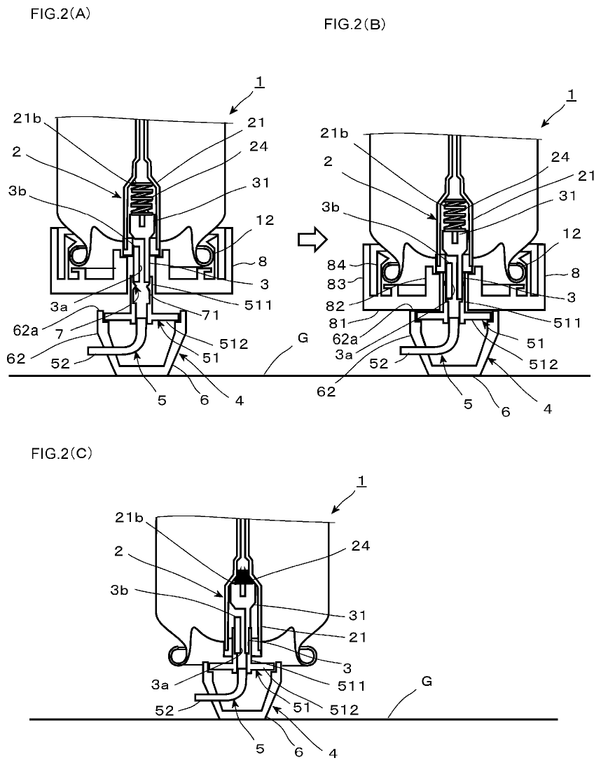

FIG. 2 schematically illustrates a state in which the stem 3 falls from a high place onto the ground G with the stem 3 facing downward. FIG. 2(A) illustrates a state before destruction of the fragile part 7, FIG. 2(B) illustrates a state after destruction of the fragile part 7, and FIG. 2(C) illustrates a state at the time of falling in the case of no fragile part.

In the case where there is no fragile part, as illustrated in FIG. 2(C), the spring 24 is pushed into the bottom wall portion 21b of the housing 21 and crushed, and the stem hole 3b is exposed to the inside of the housing 21, so that the contents are ejected.

On the other hand, in the case of the present embodiment, when an excessive force is applied, the spring 24 is contracted from the state before destruction illustrated in FIG. 2(A) to a valve opening state for a moment, and when the amount of contraction of the spring 24 further increases and its elastic restoring force reaches a predetermined force, the engagement claws 71 are destroyed, so that the valve body portion 31 is immediately pushed back by the spring force of the spring 24 to maintain a valve closed state. Therefore, since the valve is opened for a moment, the amount of leakage, if any, is small.

After the fragile part 7 is destroyed, the fixed tube portion 511 further slides with respect to the stem 3 to perform relative movement, and as illustrated in FIG. 2(B), the end portion 62a of the skirt portion 62 of the push member 6 collides with the top plate portion 81 of the protective member 8, so that the relative movement of the actuator 4 is stopped. The top plate portion 81 of the protective member 8 has high rigidity, and the weight of the entire container acts on the actuator 4, and hence, if the impact applied is large, the actuator 4 will be damaged but the protective member 8 will not be damaged.

In addition, in the illustrated example, the case where the stem 3 falls in a state of being completely downward in the direction of gravity is illustrated, but in the case of an oblique fall, not only an impact load in the axial direction is applied to the stem 3, but without the protective member 8, there is a concern that the clinch portion 12 may hit the ground and be damaged, causing the contents to leak out. In this embodiment, however, not only the valve mechanism 2 can be protected by the fragile part 7, but also the damage of the clinch portion 12 can be prevented by the protective member 8. In other words, when falling at an angle, the corners of the top plate 81 and the outer tube portion 83 of the protective member 8 collide with the ground, but since the top plate 81 is rigid, the impact does not act locally on the clinch portion 12, but is dispersed throughout, and the engagement tube portion 84 is also interfered with by elastic deformation, preventing damage to the clinch portion 12.

Moreover, if the protective member 8 is not provided, a bending moment acts on the stem 3 and the fixed tube portion 511 of the actuator 4 due to the impact at the time of falling, and an excessive bending stress acts on the stem 3, but in the present embodiment, since bending deformation is regulated by the inner tube portion 82 of the protective member 8, deformation of the stem 3 can be prevented.

Therefore, if there is no particular damage to the aerosol container 1 itself, the aerosol container 1 can be reused simply by replacing the actuator 4 with a new actuator 4, which simplifies the repair work and prevents waste of the contents and the aerosol container 1.

Further, if the safety mechanism part is configured with the fragile part 7 as in the first embodiment, there is an advantage that the actuator body 5 including the joint member 51 and the nozzle portion and the push member 6 can be integrally formed or molded, and can be manufactured at low cost.

Next, other embodiments will be described. In the following description, differences from the first embodiment will be mainly described, and the same components will be denoted by the same reference signs, and the description thereof will be omitted.

### Second Embodiment

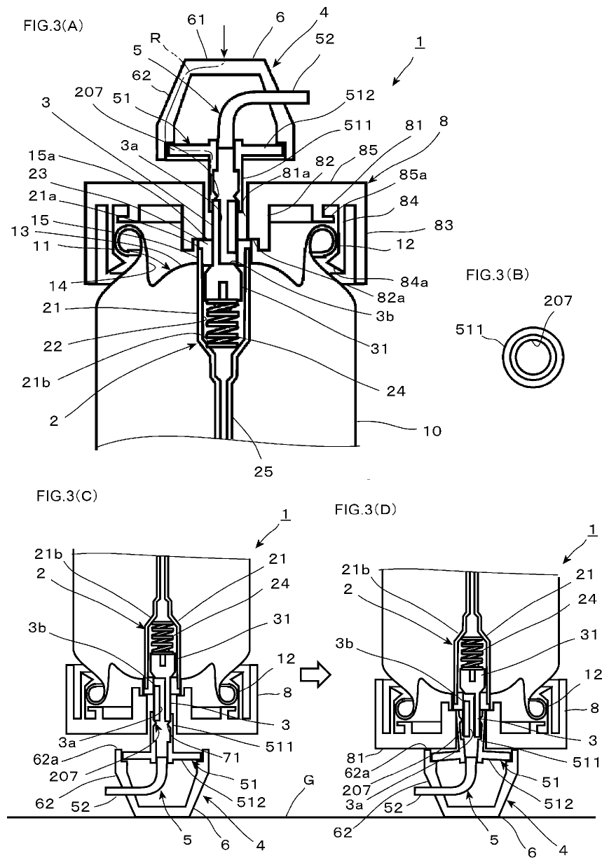

FIG. 3(A) illustrates a configuration of a main part of an aerosol container according to a second embodiment of the present invention, and FIG. 3(B) is a plan view of a small diameter portion that constitutes a safety mechanism part.

In the second embodiment, in a fitting portion between the fixed tube portion 511 of the joint member 51 and the stem 3, there is provided a small diameter portion 207, which is not a fragile part as in the first embodiment, but constitutes a frictional contact part that transmits force during normal valve opening operation, and mitigates the transmission of force due to slipping or sliding of a contact surface when an excessive external force is applied.

The small diameter portion 207 is configured such that a part of the inner peripheral surface of the fixed tube portion 511 is locally reduced in diameter and protrudes inward over the entire inner periphery so as not to be destroyed. However, instead of a shape that protrudes inward over the entire inner periphery, it is also possible to adopt a configuration in which convex portions are provided intermittently in the circumferential direction, and for example, if the width thereof in the axial direction is increased, the configuration can be made so that it cannot be destroyed.

This small diameter portion 207 is normally engaged with the distal end surface of the fixed tube portion 511, so that it transmits a pushing force from the push member 6 to the stem 3, thereby making it possible to perform a valve opening operation.

Next, with reference to FIGS. 3(C) and 3(D), the operation of this small diameter portion at the time of falling will be described. FIG. 3(C) illustrates a state before the diameter of the small diameter portion 207 is expanded, and FIG. 3(D) illustrates a state after the diameter of the small diameter portion 207 is expanded.

In the case of this second embodiment, when an excessive force is applied due to collision with the ground, the spring 24 is contracted to bring about a valve opened state for a moment, and when the amount of contraction of the spring 24 further increases and the spring force thereof reaches a maximum static friction force of the small diameter portion 207 that has been expanded in diameter, the contact surface slips so that the valve body portion 31 is immediately pushed back by the spring force of the spring 24 to maintain a valve closed state. Thus, in the case of the second embodiment, too, the valve opened state is instantaneous, and hence, the amount of leakage, if any, is minimal.

Also, in the case of the second embodiment, there is an advantage that the actuator body 5 including the joint member 51 and the nozzle portion 52 and the push member 6 can be integrally formed or molded, and can be manufactured at low cost.

Here, note that since it is sufficient to increase the static frictional force, it is also sufficient to simply set a high frictional part on the inner peripheral surface of the fixed tube portion 511 without providing the small diameter portion 207. In other words, a frictional contact part may be formed in at least a part of a contact portion with the fixed tube portion 511 fitted to the stem 3 in such a size that the force required for normal valve opening operation is transmitted without slipping, but slipping is caused when an excessive force is applied.

### Third Embodiment

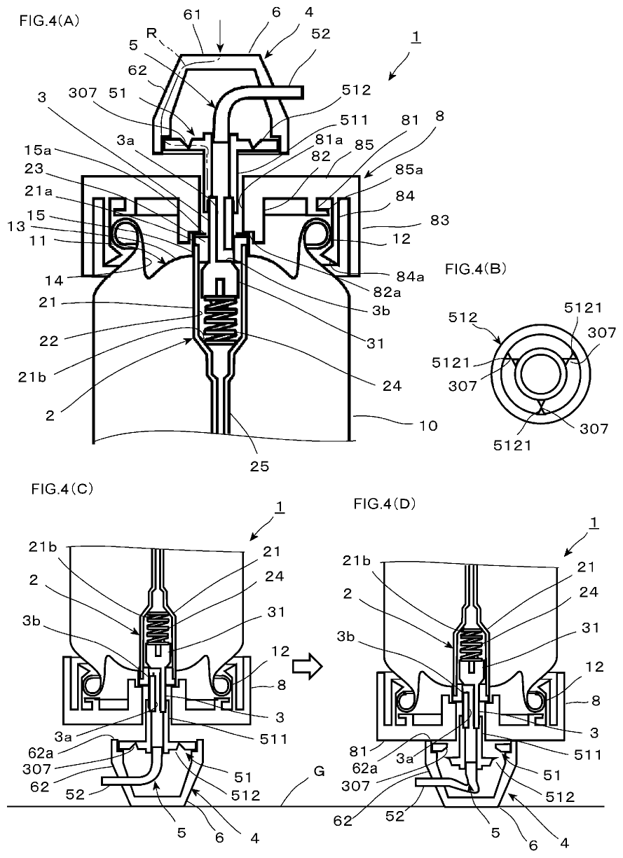

FIG. 4(A) illustrates a main part of an aerosol container according to a third embodiment, and FIG. 4(B) is a plan view of a flange fragile part that constitutes a safety mechanism part.

In the second embodiment, a flange fragile part 307 as a fragile part constituting a safety mechanism part is provided in a flange portion 512 of a joint member 51 that serves as a force transmission path R. The flange fragile part 307 is configured to transmit an operating force at the time of normal valve opening operation, and when an excessive external force is applied, the flange fragile part 307 is destroyed to mitigate the transmission of the force.

In the illustrated example, as illustrated in FIG. 4(B), the flange portion 512 is configured to be divided in the circumferential direction, and the flange fragile part 307, which is locally thinned, is provided in each divided flange portion 5121. The configuration of FIG. 4(B) is a schematic representation, and a flange fragile part 307 of each divided flange portion 5121 is indicated by a point, but has a width. That is, the flange fragile part 307 is weakened to be fragile by locally reducing both the thickness and width dimensions. In addition, the flange fragile part 307 may be formed of a material different from that of the flange portion 512, for example, an adhesive having a weak adhesive force or a brittle material.

The configuration of the flange portion 512 does not necessarily have to be a divided configuration, but an annular groove can be formed in the washer-like flange portion 512, or arc-shaped elongated holes can be intermittently formed in the washer-like flange portion, or a plurality of score lines can be formed in various ways, or indented lines can be formed to provide a fragile configuration. In short, a variety of configurations can be adopted to make it fragile.

In the case of the third embodiment, too, the flange fragile part 307 is not destroyed during normal valve opening operation, and a pushing force from the push member 6 can be transmitted to the stem 3 to perform a valve opening operation.

Next, with reference to FIGS. 4(C) and 4(D), the operation of the flange fragile part 307 at the time of falling will be described. FIG. 4(C) illustrates a state before the flange fragile part 307 is destroyed, and FIG. 3(D) illustrates a state after the flange fragile part 307 is destroyed.

In the case of this third embodiment, when an excessive force is applied due to collision with the ground, the spring 24 is contracted to bring about a valve opened state for a moment, and when the amount of contraction of the spring 24 further increases and the shear stress acting on the flange fragile part 307 reaches a breaking stress thereof, the flange fragile part 307 breaks, so that the valve body portion 31 is pushed back by the spring force of the spring 24 to maintain a valve closed state. Thus, in the case of this third embodiment, too, the valve opened state is instantaneous, and hence, the amount of leakage, if any, is minimal.

After the flange fragile part 307 is destroyed, the fixed tube portion 511 is further slid and relatively moved with respect to the stem 3, so that the nozzle portion 52 is deformed, and the end portion 62a of the skirt portion 62 of the push member 6 collides with the top plate portion 81 of the protective member 8, thereby regulating or restricting relative movement of the actuator 4. In this case, too, the top plate portion 81 of the protective member 8 has high rigidity, and the weight of the entire container acts on the actuator 4, and hence, if the impact applied is large, the actuator 4 will be damaged but the protective member 8 will not be damaged.

Further, if the safety mechanism part is configured by the flange fragile part 307 as in the third embodiment, there is an advantage that the internal structure of the actuator 4 remains unchanged, and the actuator 4 can be manufactured at low cost.

### Fourth Embodiment

Next, a fourth embodiment of the present invention will be described.

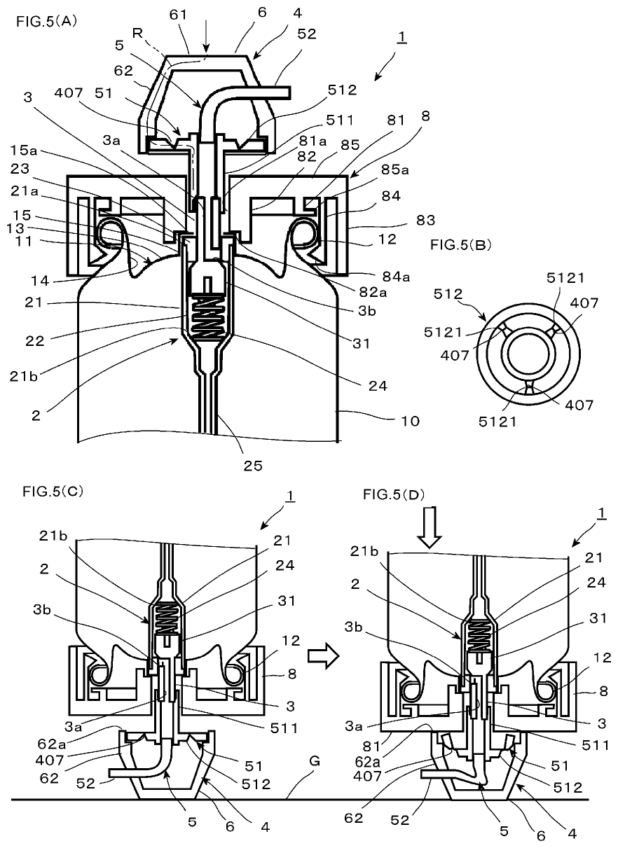

FIG. 5(A) illustrates a configuration of a main part of an aerosol container according to a fourth embodiment, and FIG. 5(B) is a plan view illustrating a flange fragile part that constitutes a safety mechanism part.

In the fourth embodiment, a flange deformable part 407, which constitutes a safety mechanism part, is formed on the flange portion 512 of the joint member 51 in the middle of the transmission path R of external force. The flange deformable part 407 transmits an operating force at the time of normal valve opening operation, but is deformed, when an excessive external force is applied, to mitigate the transmission of the force to the stem 3.

Structurally, as illustrated in FIG. 5(B), the flange portion 512 is divided in the circumferential direction, and each divided flange portion 5121 is provided with a flange deformable part 407 similar to the flange fragile part 307 of the third embodiment. The configuration of FIG. 5(B) is a schematic representation, and the flange deformable part 407 of each divided flange portion 5121 is described as having a width, unlike the flange fragile part 307, and has a breaking strength higher than that of the flange fragile part 307. This breaking strength is adjusted by the thickness and width dimensions of the flange deformable part 407.

The flange 512 can be configured not necessarily as a divided configuration, but an annular groove may be formed in the washer-like flange, arc-shaped elongated holes may be formed intermittently in the washer-like flange, a plurality of score lines may be formed in various ways, or indented lines may be formed so as to provide a deformable configuration. In short, a variety of configurations that are deformable can be adopted.

In the case of this fourth embodiment, too, during normal valve opening operation, the flange deformable part 407 is not destroyed, and a pushing force from the push member 6 can be transmitted to the stem 3 to perform a valve opening operation.

Then, with reference to FIGS. 5(C) and 5(D), the operation of this flange deformable part 407 at the time of falling will be described. FIG. 5(C) illustrates a state before the flange deformable part 407 is deformed, and FIG. 5(D) illustrates a state after the flange deformable part 407 is deformed.

In the case of the fourth embodiment, when an excessive force is applied due to collision with the ground G, the spring 24 is contracted momentarily to bring about a valve opened state, and the amount of contraction of the spring 24 further increases and the spring force thereof increases the bending stress acting on the flange deformable part 407. As a result, the flange deformable part 407 is deformed greatly, so that the valve body portion 31 is pushed back by the spring force of the spring 24 to maintain a valve closed state. Thus, in the case of the fourth embodiment, too, the valve opened state is instantaneous, and hence, the amount of leakage, if any, is minimal.

After the flange deformable part 407 is deformed, the fixed tube portion 511 is further slid and relatively moved with respect to the stem 3, so that the nozzle portion 52 is deformed, and the end portion 62a of the skirt portion 62 of the push member 6 collides with the top plate portion 81 of the protective member 8, thereby regulating relative movement of the actuator 4. In this case, too, the top plate portion 81 of the protective member 8 has high rigidity, and the weight of the entire container acts on the actuator 4, and hence, if the impact applied is large, the actuator 4 will be damaged but the protective member 8 will not be damaged.

Further, if the safety mechanism part is configured by the flange deformable part 407, there is an advantage that the internal structure of the actuator 4 remains unchanged, and the actuator 4 can be manufactured at low cost.

### Fifth Embodiment

Next, a fifth embodiment of the present invention will be described.

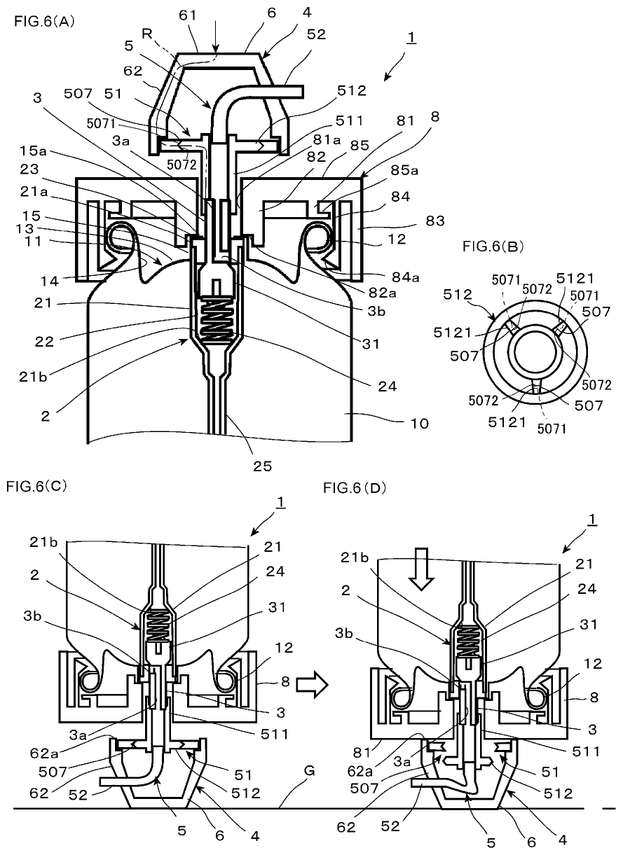

FIG. 6(A) illustrates a configuration of a main part of an aerosol container according to the fifth embodiment of the present invention, and FIG. 6(B) is a plan view of flange connecting parts that constitute a safety mechanism part.

In the fifth embodiment, the flange portion 512 of the joint member 51, which serves as the transmission path R of external force, is provided with flange connecting parts 507 that together constitute a safety mechanism part. The flange connecting parts 507 maintain a connection state and transmits force when an operating force at the time of normal valve opening operation is applied, but when an excessive external force is applied, the connection state is released or disconnected to mitigate the transmission of force to the stem 3.

Structurally, as illustrated in FIGS. 6(A) and 6(B), the flange portion 152 is configured to be divided in the circumferential direction, and each divided flange portion 5121 is provided with a flange connecting part 507. Each divided flange connecting part 507 has a first convex connecting end portion 5071 and a second concave connecting end portion 5072, which are connected with each other in the radial direction, and remain connected even when a force in the shearing direction acts in the axial direction.

The configuration of the flange portion 512 is not necessarily a divided configuration, and the first connecting end portion 5071 and the second connecting end portion 5072 may have an annular configuration or may be configured to be fitted to each other in the axial direction.

In the case of this fifth embodiment, too, at the time of normal valve opening operation, the flange connecting parts 507 are not separated, and a pushing force from the push member 6 can be transmitted to the stem 3 to perform a valve opening operation.

Then, with reference to FIGS. 6(C) and 6(D), the operation of these flange connecting parts 507 at the time of falling will be described. FIG. 6(C) illustrates a state before the flange connecting parts 507 are separated, and FIG. 6(D) illustrates a state after the flange connecting parts 507 are separated.

In the case of this fifth embodiment, too, when an excessive force is applied due to collision with the ground G, the spring 24 is contracted to bring about a valve opened state for a moment, and when the amount of contraction of the spring 24 further increases and a shear force acting on the flange connecting part 507 becomes larger than a shear force required for separation thereof, the flange connecting parts 507 are separated, so that the valve body portion 31 is pushed back by the spring force of the spring 24 to maintain a valve closed state. Also, in the case of the fifth embodiment, the valve opened state is instantaneous, and hence, the amount of leakage, if any, is minimal.

After the flange connecting parts 507 are separated, the fixed tube portion 511 further slides and moves relative to the stem 3, the nozzle portion 52 positioned in the transmission path of external force is deformed, so that the end portion 62a of the skirt portion 62 of the push member 6 collides with the top plate portion 81 of the protective member 8, thereby regulating relative movement of the actuator 4. In this case, too, the top plate portion 81 of the protective member 8 has high rigidity, and the weight of the entire container acts on the actuator 4, and hence, if the impact applied is large, the actuator 4 will be damaged but the protective member 8 will not be damaged.

In addition, if the safety mechanism part is configured by the flange connecting parts 507, there is an advantage that the internal structure of the actuator 4 remains unchanged, and the actuator 4 can be manufactured at low cost.

Further, if the actuator is damaged to such an extent that does not affect its reuse, it can be reused by reconnecting the separated flange connecting parts 507. In the case of reuse, the nozzle portion 52 may be made of a flexible material such as rubber or the like so that the deformation of the nozzle portion 52 can be restored.

Here, note that in the above-described first through fifth embodiments, an example has been described in which the safety mechanism part is provided in the fitting portion of the fixed tube portion 511 or in the flange portion 512, but the safety mechanism part may also be provided in the push member 6 or may be provided in a connection portion between the push member 6 and the flange portion 512.

### Sixth Embodiment

Next, a sixth embodiment of the present invention will be described.

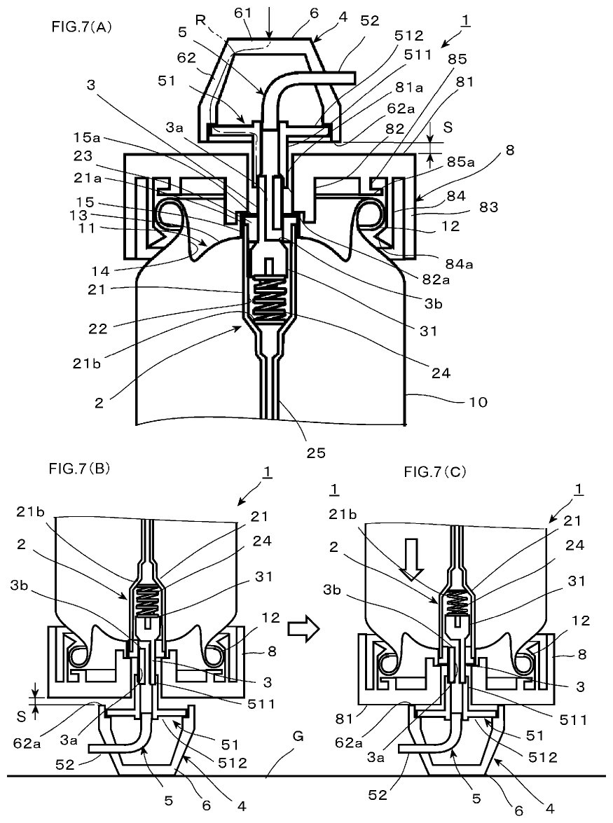

FIG. 7(A) illustrates a configuration of a main part of an aerosol container according to the sixth embodiment.

In the sixth embodiment, the protective member 8 against which the skirt portion 62 of the push member 6 of the actuator 4 abuts is used as a stopper to regulate the stroke of the stem 3, whereby the transmission of force is blocked to prevent the end portion of the stem 3 from being damaged by biting into the housing 21 of the valve mechanism 2. In the figure, S represents a stroke regulation amount, which is set by a distance or clearance between the end portion 62a of the skirt portion 62 of the push member 6 and the top plate portion 81 of the protective member 8 in a valve opened state.

The stroke regulation amount S of the stem 3 is set to be equal to or less than a maximum stroke at which the stem 3 will not damage the valve mechanism 2, and equal to or more than a stroke required for discharge. The stroke required for discharge is from a position where the stem hole 3b in the stem 3 is hidden by the gasket 23 to a position where it is fully exposed to the valve chamber 22 side. In addition, the maximum stroke is set by, for example, the most contracted position of the spring 24 or the position where the end of the stem 3 abuts against the bottom wall of the housing 21.

Next, referring to FIGS. 7(B) and 7(C), the regulation operation of the stopper of the stem 3 by the protective member 8 will be described. FIG. 7(B) illustrates a state before stroke regulation, and FIG. 7(C) illustrates a state after stroke regulation.

In the case of this sixth embodiment, when an excessive force is applied due to collision with the ground G, the spring 24 is contracted to bring about a valve opened state, and when it reaches a predetermined stroke, the end portion 62a of the skirt portion 62 of the push member 6 collides with the top plate 81 of the protective member 8, as illustrated in FIG. 7(C), so that the relative movement of the actuator 4 is stopped. After the collision, the container bounces back due to the reaction of the collision, so that the valve body portion 31 is pushed back by the spring force of the spring 24 to maintain a valve closed state. Thus, in the case of the sixth embodiment, too, the valve opened state is instantaneous, and hence, the amount of leakage, if any, is minimal.

The top plate portion 81 of the protective member 8 has high rigidity, and the weight of the entire container acts on the actuator 4, and hence, if the impact applied is large the actuator 4 will be damaged, but the protective member 8 will not be damaged.

In the case of the sixth embodiment, there are no fragile, deformable, or connecting parts and the like as those in the first through fifth embodiments, and hence, reliability is high, and the actuator 4 is easy to manufacture.

Here, note that since it is sufficient to regulate the stroke, the flange portion 512 of the joint member 52 may be used as a stopper portion instead of the skirt portion 62 of the push member 6, or a separate stopper may be provided.

### Seventh Embodiment

Next, a seventh embodiment of the present invention will be described.

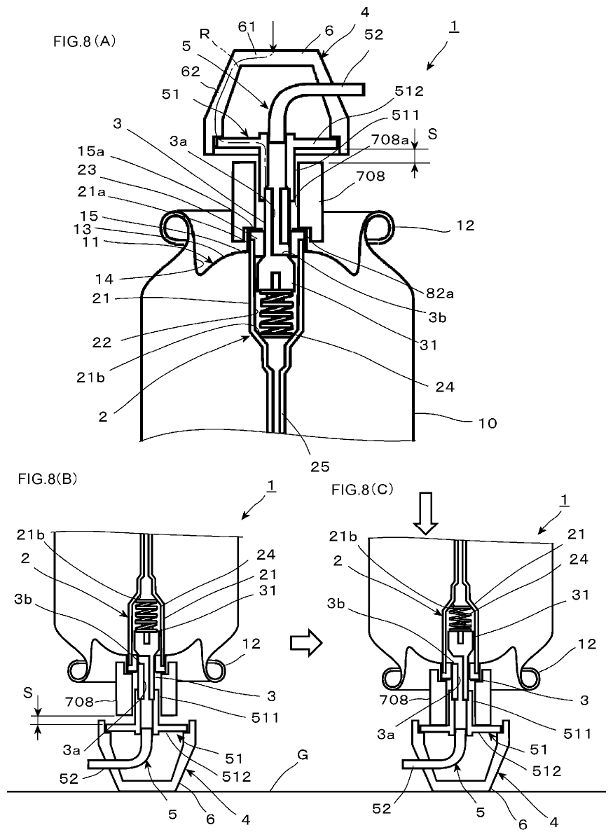

FIG. 8(A) is a cross-sectional view of a configuration of a main part of an aerosol container according to the seventh embodiment.

The seventh embodiment differs from the sixth embodiment in that the protective member 8 is not used, but a stopper 708 is mounted between the actuator 4 and the central protruding portion 15 of the mounting cup 11. This stopper 708 is configured such that it has a thick-walled cylindrical shape with a through hole 708a in its center through which the stem and the fixed tube portion of the actuator are inserted, and it is engaged at its one end with a corner portion of a central end face of the mounting cup 11, so that when an external force is applied, the flange portion 512 of the joint member 51 of the actuator 4 abuts against the stopper 708 to regulate the stroke of the stem. In the figure, S represents a stroke regulation amount, which is set by a distance between the flange portion 521 and an upper end face of the stopper 708 in a valve opened state. The outer diameter of the stopper 708 is larger than that of the central projecting portion 15 of the mounting cup 11, so that the upper end face thereof is in surface contact with the flange portion 521 of the joint member 52.

The protective member 8 is to regulate the stroke of the actuator 4 to a minimum stroke required for valve opening. This stroke S is set so that an initial clearance is equal to or less than the maximum stroke of the stem 3 and equal to or more than the stroke required for discharge.

Then, the operation of a stopper mechanism between the protective member 8 and the push member 6 of the actuator 4 will be described with reference to FIGS. 8(B) and 8(C). FIG. 8(B) illustrates a state before stroke regulation, and FIG. 6(C) illustrates a state after stroke regulation.

When the actuator 4 collides with the ground G, the spring 24 is contracted due to the impact to bring about a valve opened state, and when it reaches a predetermined stroke, as illustrated in FIG. 8(C), the flange portion 512 of the joint member 51 of the actuator 4 collides with the end face of the stopper 708, thereby regulating or restricting the relative movement thereof. After the collision, the container bounces back due to the reaction of the collision, so that the valve body portion 31 is pushed back by the spring force of the spring 24 to maintain a valve closed state. Thus, in the case of the seventh embodiment, too, the valve opened state is instantaneous, and hence, the amount of leakage, if any, is minimal.

The stopper 708 has high rigidity, and the weight of the entire container acts on the actuator 4, and hence, if the impact applied is large, the actuator 4 will be damaged, but the stopper 708 will not be damaged.

Also, in the case of the seventh embodiment, there are no fragile, deformable or connecting parts and the like as those in the first through fifth embodiments, and hence, reliability is high, and the actuator 4 itself is easy to manufacture.

Here, note that the stopper 708 of the seventh embodiment may be used in combination with a protective member that protects only the clinch portion 12. The protective member that protects only the clinch portion 12 means that it does not function as a safety mechanism for a valve, but protects only the clinch portion 12, and such a type of protective member as having no top plate portion 81 with which the actuator 4 of the protective member 8 of the sixth embodiment abuts or a sleeve can be applied. The type of protective member without the top plate portion 81 of the sixth embodiment has a configuration in which, for example, in FIG. 7(A), the top plate portion 81 does not have a part with which the actuator 4 abuts, and an annular portion of the top plate portion 81 remains where the outer tube portion 82, the engagement tube portion 84, and the abutment tube portion 85 are provided. In addition, the sleeve is a tubular member disposed so as to surround the periphery of the clinch portion 12, and may be fixed to the clinch portion 12, or may be configured so as to cover a part or the whole of the body portion of the container body 10 from the clinch portion 12 and may be fixed to the container body 10. Further, it may be configured to cover and house the bottom side of the container body 10. In short, any configuration that protects the clinch portion 12 may be employed.

### Eighth Embodiment

Next, an eighth embodiment of the present invention will be described.

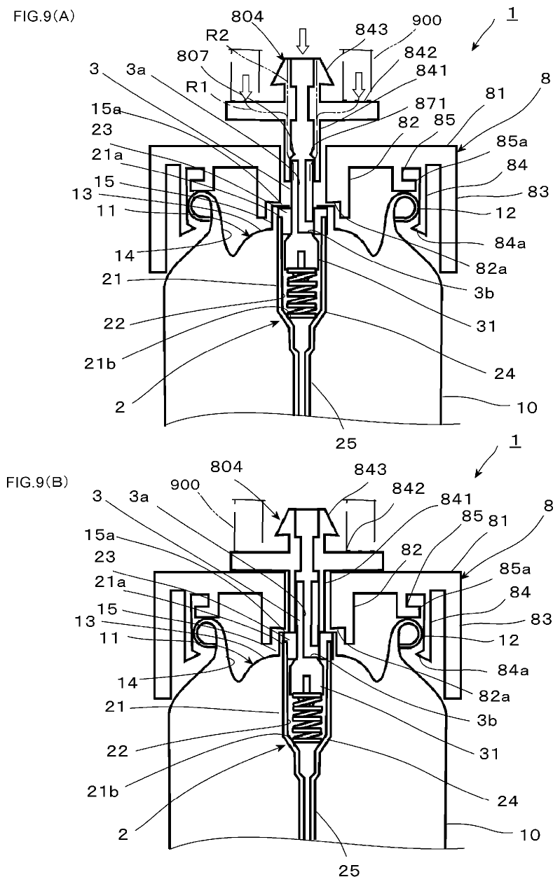

FIG. 9(A) is a cross-sectional view of a main part of an aerosol container before a fragile part is destroyed according to the eighth embodiment, and FIG. 9(B) is a cross-sectional view of the main part of the aerosol container in a state where the fragile part is destroyed.

Unlike the first through seventh embodiments described above, an actuator 804 of the eighth embodiment does not have a push member operated by a finger, but it is configured such that the actuator 804 is driven in a direction of being pushed in the axial direction of the stem 3 by an unillustrated driving device to automatically discharge the contents.

The actuator 804 is configured to include a fixed tube portion 841 that is fitted to the stem 3, a flange portion 842 that extends radially outward from one end of the fixed tube portion 841, and a nozzle portion 843 that protrudes in a direction opposite to the fixed tube portion 841 with respect to the flange portion 842. In this example, the nozzle portion 843 is integrally formed with the fixed tube portion 841 and the flange portion 842, but may be separately formed, and may be bent instead of having a linearly extending configuration.

The driving device may be configured to fix the container body 11 of the aerosol container 10 and push in the flange portion 842, or may be configured to fix the flange portion 842 and push up the container body 10. In either case, a driving engagement member 900 engages with the flange portion 842, so that a driving force is transmitted from the driving engagement member 900 to the stem 3 via the flange portion 842 and the fixed tube portion 841

There are two paths through which external forces are transmitted at the time of falling: a first path R1 from the driving engagement member 900 side to the stem 3 through the flange portion 842 and the fixed tube portion 841, and a second path R2 from the nozzle 841 to the stem 3 through the fixed tube portion 841.

In this eighth embodiment, a fragile part 807 as a safety mechanism part is configured by engagement claws 871 formed on the inner periphery of the fixed tube portion 841, as in the first embodiment.

In the case of the present embodiment, when an excessive force is applied to the actuator 804 due to falling or the like, the spring 24 is contracted from the state before destruction illustrated in FIG. 9(A) to bring about a valve opened state for a moment, and when the amount of contraction of the spring 24 further increases and its elastic restoring force reaches a predetermined force, the engagement claws 871 are destroyed, so that the valve body portion 31 is immediately pushed back by the spring force of the spring 24 to maintain a valve closed state.

After the fragile part 7 is destroyed, the fixed tube portion 841 further slides with respect to the stem 3 to perform relative movement, and as illustrated in FIG. 9(B), the flange portion 842 collides with the top plate portion 81 of the protective member 8, so that the relative movement of the actuator 4 is stopped.

The safety mechanism part is not limited to the configuration of the fragile part 807 of the fixed tube portion 841, but may be configured to have the small diameter portion of the second embodiment, the flange fragile parts of the third embodiment, or the flange connecting part of the fourth embodiment. In addition, as in the fifth embodiment, the stroke of the stem may be regulated by using the protective member 8 as a stopper, or as in the sixth embodiment, a stopper 708 may be provided to regulate the stroke.

As described above, according to the aerosol container in each of the above-described embodiments, for example, in cases where an excessive external force such as the impact of falling from a high place of a construction site, an unmanned aerial vehicle or the like is applied, the valve mechanism can be prevented from being damaged by the action of the safety mechanism part.

### DESCRIPTION OF REFERENCE SIGNS

1 aerosol container

2 valve mechanism
21 housing, 21a distal end surface, and 21b bottom wall
22 valve chamber
23 gasket, 24 spring, 25 nipple portion
26 dip tube

3 stem, 3a discharge flow path, 3b stem hole

31 valve body portion

4 actuator

5 actuator body

51 Joint member

511 fixed tube portion
512 flange portion, 5121 divided flange portion
52 nozzle portion

6 push member
61 top plate portion, 62 skirt portion, 62a end portion

7 fragile part
71 engagement claw

8 protective member
81 top plate portion, 81a hole
82 inner tube portion, 82a engagement step portion
83 outer tube portion
84 engagement tube portion, 84a engagement projection, 85 abutment tube portion, 85a overhang piece

10 container body

11 mounting cup
13 lid portion, 14 fixed wall
15 central protruding portion, 15a central end wall

12 clinch portion

207 small diameter portion (safety mechanism part, frictional contact portion)

307 flange fragile part (safety mechanism part, fragile part)

407 flange deformable part (safety mechanism part, deformable part)

507 flange connecting portion (safety mechanism part)
5071 first connecting end, 5072 second connecting end

708 stopper

804 actuator
841 fixed tube portion, 842 flange portion, 843 nozzle portion

807 fragile part, 871 engagement claw

900 driving engagement member

G ground

R, R1, R2 transmission path of external force

S stroke regulation amount

1. An aerosol container in which an actuator is attached to a stem, comprising a safety mechanism part provided in a part of a path through which an external force is transmitted to the stem, the safety mechanism part being configured to prevent breakage of a valve mechanism of the aerosol container against an excessive external force which exceeds a force required for discharge operation of contents and which may damage the valve mechanism.

2. The aerosol container as set forth in claim 1, wherein the safety mechanism part is a fragile part that is destroyed by the excessive external force.

3. The aerosol container as set forth in claim 1, wherein the safety mechanism part is a frictional contact portion in which a contact surface slips due to the excessive external force to mitigate transmission of the force.

4. The aerosol container as set forth in claim 1, wherein the safety mechanism part comprises a deformable part in which transmission of force is mitigated by its deformation due to the excessive external force.

5. The aerosol container as set forth in claim 1, wherein the safety mechanism part comprises connecting parts adapted to be fitted to each other, the fitting thereof being released by the excessive external force.

6. The aerosol container as set forth in claim 1, wherein the safety mechanism part is configured to block transmission of the external force by a stopper that regulates a stroke of the stem.

7. The aerosol container as set forth in claim 1, further comprising a protective member covering a clinch portion that fixes a container body portion and a lid body.

8. The aerosol container as set forth in claim 1, wherein the actuator has a fitting portion to be fitted to the stem, and the safety mechanism part is provided in the fitting portion.

9. The aerosol container as set forth in claim 1, wherein the actuator has a flange portion protruding from a fitting portion to be fitted to the stem, and the safety mechanism part is provided in the flange portion.

10. An actuator for an aerosol container in which the actuator is adapted to be attached to a stem of the aerosol container, comprising a safety mechanism part provided in a part of a path through which an external force is transmitted from the actuator to the stem, the safety mechanism part being configured to prevent breakage of a valve mechanism of the aerosol container against an excessive external force which exceeds a force required for discharge operation of contents and which may damage the valve mechanism.

11. A protective member for an aerosol container, comprising: an engagement portion adapted to engage with a clinch portion that fixes a body portion and a lid portion of the aerosol container; and a protective member main body that covers the clinch portion.

12. The aerosol container as set forth in claim 2, wherein the actuator has a fitting portion to be fitted to the stem, and the safety mechanism part is provided in the fitting portion.

13. The aerosol container as set forth in claim 3, wherein the actuator has a fitting portion to be fitted to the stem, and the safety mechanism part is provided in the fitting portion.

14. The aerosol container as set forth in claim 2, wherein the actuator has a flange portion protruding from a fitting portion to be fitted to the stem, and the safety mechanism part is provided in the flange portion.

15. The aerosol container as set forth in claim 4, wherein the actuator has a flange portion protruding from a fitting portion to be fitted to the stem, and the safety mechanism part is provided in the flange portion.

16. The aerosol container as set forth in claim 5, wherein the actuator has a flange portion protruding from a fitting portion to be fitted to the stem, and the safety mechanism part is provided in the flange portion.
